(19) United States
(12) Patent Application Publication
(10) Pub. No.: US 2002/0046503 A1
(43) Pub. Date: Apr. 25, 2002

(54) Door module for motor vehicle doors

(76) Inventor: Gerhard Mersch, Hannover (DE)

Correspondence Address: David J. Gaskey, CARLSON, GASKEY & OLDS, P.C., Suite 350, 400 West Maple Road, Birmingham, MI, 48009, US

(21) Appl. No.: 09/931,489

(22) Filed: Aug. 21, 2001

(30) Foreign Application Priority Data
Aug. 22, 2000 (DE) 100 40 954.7

(51) Int. Cl. B60J 5/04

(52) U.S. Cl. 49/502

(57) ABSTRACT

A door module intended for fitting in motor vehicle doors has a system carrier, which is preferably molded in the shape of a plate from a plastics material and is formed for positioning a window lifter unit, preferably a cable window lifter. An electric drive unit of the window lifter unit bears a housing for the control electronics, which is partly fastened to the drive unit in a sealed manner and partly constituted by the system carrier. When the drive unit is positioned on the system carrier the housing is closed in one operation with a sealing action, with the drive unit being directly electrically connected at the same time by means of plug-in contacts and complementary mating contacts, which are engaged in an electrically conductive manner when the housing is closed.

### BRIEF DESCRIPTION OF THE PRIOR ART

The invention relates to a door module intended for fitting in a motor vehicle door.

A drive unit, which consists of a geared motor, i.e. an electric motor with a connected gear unit, for electric motor-operated window lifters fitted in motor vehicle doors for raising and lowering window glass is disposed in a moisture-proof housing. According to a known proposal (DE 40 19 787 A1), in order to reduce expenditure on components and assembly, the associated control and regulating electronics should essentially be disposed in the housing of the drive unit, so that there is no need for additional cabling between the drive unit and the control and regulating circuit. The control and regulating circuit can in this case be formed as a plug-in member which can be plugged into the housing of the drive unit and connected thereto in a sealed manner. The required plug connections for the power supply to the drive unit are effected when this plug-in member is plugged in. However a moisture-proof cable bushing for a plug-in power and signal connection must also be provided at the housing or at the plug-in member in this known arrangement to establish the connection to an operating switch and the power supply.

An object of the invention is to further simplify the assembly of the members required in motor vehicle doors for the raising and lowering movement of window glass, while simultaneously reducing the number of construction members to be used for this.

According to the present invention, there is provided a door module for fitting in a motor vehicle door, the door module having a system carrier and a window lifter unit, which is fitted to the system carrier, the window lifter unit comprising window glass guide members, an electric drive unit with a housing positioned thereon, the housing being for housing a drive unit, control electronics and movement transmission means, driven by the drive unit, for raising and lowering a window glass associated with the window lifter, wherein the housing has a part for the control electronics which part is constituted by the system carrier.

In a more general summary, the door module proposed by the invention for fitting in motor vehicle doors is formed as a system carrier, to which a window lifter unit is fastened, the latter comprising window glass guide members, an electric drive unit with a housing positioned thereon for the control electronics and movement transmission means, driven by the drive unit, for raising and lowering the window glass. In this case one part of the housing for the control electronics is constituted by the actual system carrier. The door module consists of few parts, which can easily be assembled to form an operational unit ready to be fitted. An important factor in this respect is that the system carrier partly constitutes the housing for the control electronics, which is not closed until the drive unit is connected to the system carrier.

It is preferable to use a window lifter of the cable lifter type in which cable lengths guided in Bowden cable casings constitute the movement transmission means, which act with one end on drivers for the window glass, which can be displaced at the window glass guide members formed as guide rails, and are applied at the other end to a cable drum, which may optionally be driven in both directions of rotation by the drive unit. However other suitable window lifters are those of the cable lifter type which employ compression-rigid threaded cables as movement transmission means, the threaded winding of which is engaged like a rack with a pinion which can optionally be driven in both directions of rotation by the drive unit.

In a simple embodiment, the system carrier may be formed like a plate and constitute the rear wall of the housing for the control electronics.

In order to prevent moisture from penetrating into the housing accommodating the control electronics, a seal extending around the housing circumference is disposed between the housing part of the housing for the control electronics which is positioned on the drive unit and the housing part constituted by the system carrier, this seal becoming effective when the two housing parts are joined. In this respect the seal is expediently secured to one of the two housing parts and is in a way brought along by this housing part when assembly takes place, not having to be inserted first.

Plug-in contacts for the power and signal supply may be positioned via cables connected thereto on the housing part constituted by the system carrier, with which contacts complementary mating contacts in the housing part positioned on the drive unit are associated such that the plug-in contacts and the mating contacts are engaged in an electrically conductive manner when the two housing parts are joined. The drive unit is thus automatically electrically connected when the drive unit is assembled at the system carrier. As both the plug-in contacts and the complementary mating contacts are provided inside the housing for the control electronics, the contact pairs lie inside the space which is safeguarded by sealing measures against the penetration of moisture. Two different types of connection can be provided for connecting the two housing parts, these being releasable in the same way. For the two housing parts can be connected together by interlocking or screwing, the interlocking method enabling assembly to be carried out particularly quickly.

### BRIEF DESCRIPTION OF THE DRAWINGS

Other details of the invention are illustrated further, by way of example, in the following on the basis of the drawings which represent embodiments in diagrammatic form and in which:

FIG. 1 is a perspective interior view of a door module in a first embodiment, in which the parts of the drive unit and of the housing for the control electronics which are to be fastened to this are represented in the manner of an exploded illustration,

FIG. 2 is a broken-out section through the parts of the housing for the control electronics taken on line II-II in FIG. 1,

FIG. 3 is a perspective interior view, similar to FIG. 1, of a door module in a second embodiment, again partly in an exploded representation, and

FIG. 4 shows the broken-out section through the parts of the housing for the control electronics according to the intersection line IV-IV in FIG. 3.

### DESCRIPTION OF THE PREFERRED EMBODIMENT

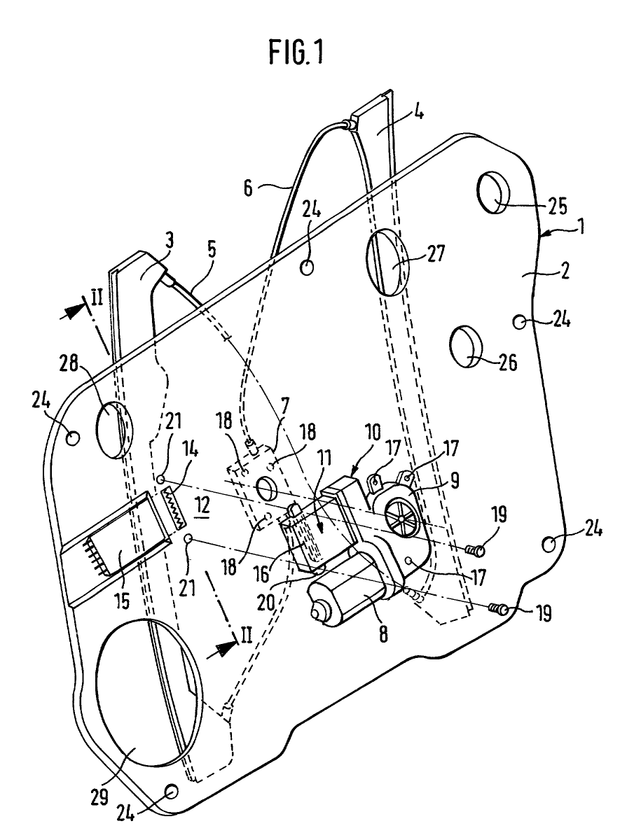

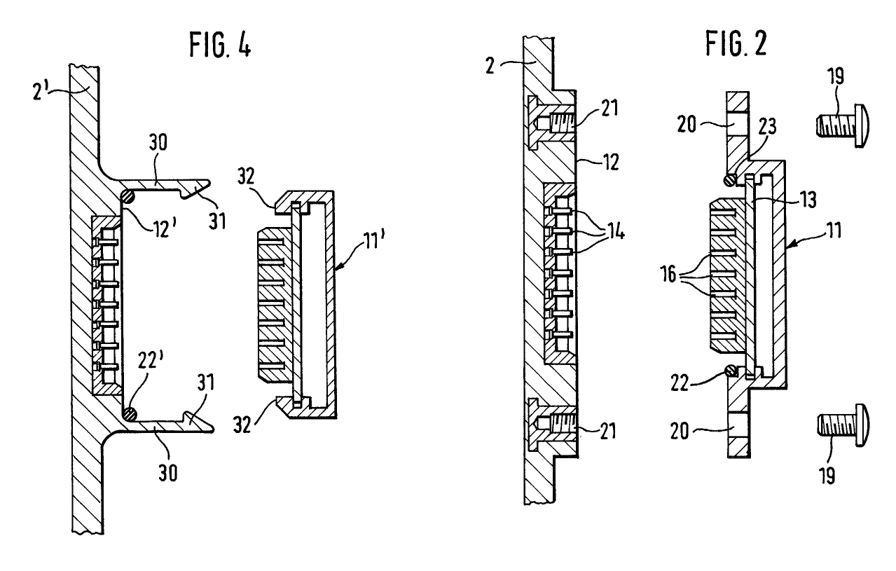

The door module 1 which is represented in FIGS. 1 and 2 has a plate-shaped system carrier 2, which is formed for assembly in the window channel of a motor vehicle door (not shown) between the outer door shell and the inner door shell. The plate-shaped system carrier 2 is preferably molded from a suitable plastics material, possibly recycled plastics material, in adaptation to any door curvatures and may be reinforced with glass fibers in order to improve its dimensional stability and loading capacity. It may be between approximately 5 and 10 mm thick.

The parts of the window lifter unit which can be seen in FIG. 1 are guide rails 3 and 4, which are positioned on the outside of the door module 1, as guide members of the window glass (not represented). Bowden cables 5 and 6 of the window lifter of the cable lifter type are provided as movement transmission means. The cable lengths, which can be displaced in the Bowden cable casings, are applied to a cable drum, only the housing 7 of which can be seen in FIG. 1, this being located on the outside of the door module 1. The gear unit of a drive unit 10, which consists of an electric motor 8 and a gear system 9, is in driving engagement with the cable drum through the system carrier 2. The drive unit 10 is located on the inside of the door module 1. Cable lifters of this kind are known per se and therefore do not need to be described in detail at this point.

The housing 11 for the control electronics is fastened in a sealed manner to the drive unit 10. A part of this housing, i.e. the rear wall 12 in the embodiment, is constituted by the actual system carrier 2, as can best be seen in FIG. 2. The control electronics are only indicated symbolically in FIG. 2 as a printed circuit board 13, which is held in the housing 11.

Plug-in contacts 14 for the power and signal supply to the drive unit 10 are positioned in the rear wall 12 constituted by the system carrier 2. Electrical conductors, which in the illustrated example are component parts of a so-called ribbon cable 15, are connected to these plug-in contacts 14. Complementary mating contacts 16, which are electrically connected to the components of the printed circuit board 13, are associated with the plug-in contacts 14. In the illustrated example the mating contacts 16 are fastened to the printed circuit board 13.

The drive unit 10 is positioned on the system carrier 2 by screws (not represented), which engage in threaded holes 18 in the drum housing 7 through fastening holes 17 in the gear system 9 and through corresponding holes (not represented) in the system carrier 2.

The housing part of the housing 11 which is positioned on the drive unit 10 is joined to the rear wall 12, located at the system carrier 2, of the housing 11 at the same time as the drive unit 10 is positioned, the plug-in contacts 14 engaging with the mating contacts 16 in an electrically conductive manner.

The two housing parts of the housing 11 are also screwed together by screws 19 in the embodiment according to FIGS. 1 and 2, these screws being passed through holes 20 in the housing part on the drive side and engaging in threaded nuts 21, which are molded into the plastics material of the system carrier 2.

A seal 22, which becomes effective when the two housing parts are joined, is provided between the housing part of the housing 11 which is positioned on the drive unit 10 and the rear wall 12 of the housing 11 which is constituted by the system carrier 2. In the example according to FIGS. 1 and 2 the seal 22 extending around the housing circumference is formed as an O-ring seal, which is secured to a circumferential step 23 of the housing part of the housing 11 which is on the drive side.

Fastening apertures 24, which serve to assemble the door module 1 at the motor vehicle door, are indicated in the edge region of the system carrier 2 in FIG. 1. The reference numerals 25 to 29 designate assembly apertures or loudspeaker locating apertures.

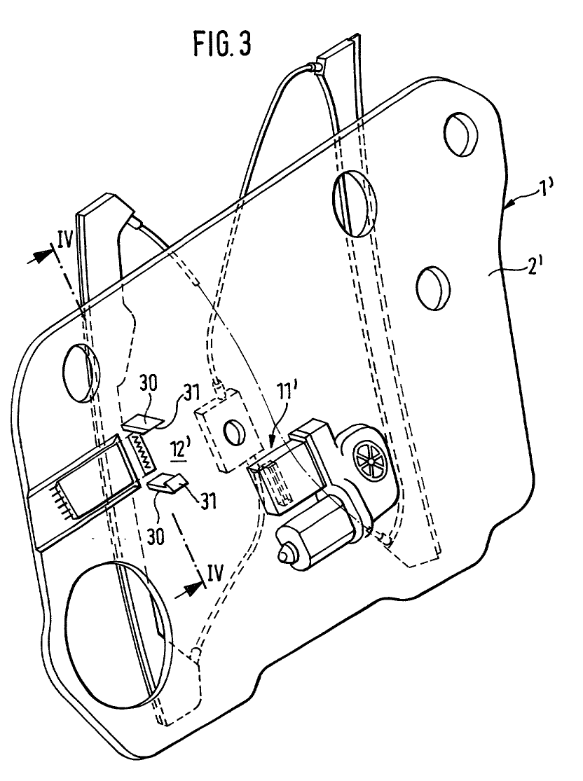

The second embodiment of the door module 1′ which is shown in FIGS. 2 and 3 only differs from the previously described first embodiment by a different method of fastening the two housing parts of the housing 11′ together and the positional association of the seal 22′, which is why no details are shown. Whereas in the first embodiment the two housing parts are fastened to one another by screws, in the second embodiment this function is performed by resilient locking projections 30, which are located in the region of the rear wall 12′ and engage in a releasable manner by way of locking hooks 31 with the housing part of the housing 11′ which is on the drive side. In the second embodiment the circumferential seal 22′, which is likewise in the form of an O-ring seal, is secured to the rear wall 12′ and, when the two housing parts 11 of the housing are joined, comes into contact in a sealing manner with a sealing face 32, which faces it, of the housing part which is on the drive side.

I claim:

1. A door module for fitting in a motor vehicle door, the door module having a system carrier and a window lifter unit, which is fitted to the system carrier, the window lifter unit comprising window glass guide members, an electric drive unit with a housing positioned thereon, the housing being for housing a drive unit, control electronics and movement transmission means, driven by the drive unit, for raising and lowering a window glass associated with the window lifter, wherein the housing has a part for the control electronics which part is constituted by the system carrier.

2. A door module according to claim 1, wherein the window lifter is of a cable lifter type, in which cable lengths with two ends guided in Bowden cable casings constitute a movement transmission means, which act with one end on drivers for the window glass, which can be displaced at the window glass guide members formed as guide rails, and are applied at the other end to a cable drum, which may be driven in both directions of rotation by the drive unit.

3. A door module according to claim 1, wherein the system carrier is formed like a plate and constitutes a rear wall of the housing for the control electronics.

4. A door module according to claim 1, wherein a seal extending around a circumference of the housing is disposed between the housing part of the housing for the control electronics which is positioned on the drive unit and the firstmentioned housing part constituted by the system carrier, this seal becoming effective when the two housing parts are joined.

5. A door module according to claim 1, wherein plug-in contacts for the power and signal supply are positioned via cables connected thereto on the housing part constituted by the system carrier, with which contacts complementary mating contacts in the housing part positioned on the drive unit are associated, such that the plug-in contacts and the mating contacts are engaged in an electrically conductive manner when the two housing parts are joined.

6. A door module according to claim 1, wherein the two housing parts can be connected together by interlocking or screwing.
